(19) United States
(12) Patent Application Publication
(10) Pub. No.: US 2010/0123435 A1
(43) Pub. Date: May 20, 2010

(54) REDUCTION OF PEAK CURRENT REQUIREMENTS

(75) Inventors: William J. Piazza, Holly Springs, NC (US); Justin Bandholz, Cary, NC (US); William G. Pagan, Durham, NC (US)

Correspondence Address: STREETS & STEELE - IBM CORPORATION, 13100 WORTHAM CENTER DRIVE, SUITE 245, HOUSTON, TX, 77065, US

(73) Assignee: International Business Machines Corporation, Armonk, NY (US)

(21) Appl. No.: 12/273,148

(22) Filed: Nov. 18, 2008

(51) Int. Cl. H02J 7/00; H02J 1/10

(52) U.S. Cl. 320/128; 307/59

(57) ABSTRACT

Method and apparatus are provided for controlling electrical current supplied to an electronic device, such as a computer system. The method includes drawing up to a predetermined amount of an electrical input current from a first current source, and supplying a first portion of the drawn electrical input current to the electronic device, wherein the amount of the first portion may change over time to supply the amount of electrical current demanded by the electronic device without exceeding the predetermined amount. A second portion is supplied to charge an energy storage device during a period that the first portion is less than the predetermined amount. The stored energy device is discharged, as needed, to supply supplemental electrical current to the electronic device. A power supply including an energy storage device, such as a rechargeable battery, may be used to carry out the method.

### BACKGROUND OF THE INVENTION

1. Field of the Invention

The present invention relates to managing the amount of power drawn by an electronic device, and more specifically to reducing the peak current that is drawn by an electronic device.

2. Background of the Related Art

Power management is important for many aspects of operating a computer system, such as to minimize the costs of operating one or more computers, control the heat generated by the computers, and to optimize the performance and efficiency of the system. A feedback-based power management system may involve, for example, a motherboard having a built-in power meter circuit, ACPI, and other hardware and/or software elements. Systems may be powered by a common power supply or power distribution unit (PDU). Some of the systems include a circuit, such as a Baseboard Management Controller (BMC), that a service processor uses to monitor real-time power consumption by a computer, such as a server in a rack system. Using this feedback, the service processor can “throttle” the processors and/or memory on the server to maintain the power consumption below a set point or “power ceiling” set by an administrator and monitored by the chassis management module.

A number of methods are known for controlling power consumption of servers individually. These methods include various methods of “power capping.” Power capping involves enforcing a power limit upon a server by selectively reducing processor performance. The server may enforce the power limit, for example, using the power meter to measure the amount of power drawn and instantaneously responding to increases in power consumption by throttling the processors and/or memory when a power threshold is reached. While power-capping techniques are useful for managing power consumption of a server individually, other system-wide parameters also need to be considered. For example, power constraints on the system as a whole need to be considered, in addition to managing power consumption to the servers individually. Furthermore, the aggregate margins between each server's power cap and its actual power consumption represents unused power availability. Software power capping tools, such as ADVANCED ENERGY MANAGER (a trademark of International Business Machines Corporation, Armonk, N.Y.), can be used to limit the power consumption of a computer system. However, because software is subject to modification or failure, regulations generally prohibit reliance on software to control the total power to the system.

Modern data centers include large numbers of electronic components that require electrical power to operate. In fact, sufficient power capacity must be provided to support each of the electronic components over an operating range up to the maximum possible power that the components can draw. The maximum possible power drawn by an electronic component, or group of components, is sometimes referred to as the maximum label power. In a rack for supporting and operating computer systems, such as a group of servers and supporting hardware, the power circuits must be able to supply enough power to operate the rack at the most extreme configuration of components and the maximum workload scenario. This is the case even though the actual operating power may be only about 30% to 70% of the maximum label power. Furthermore, regulations generally require that the rack power circuits have the capacity to provide 20% more power than the sum of the maximum label power for each electronic component. Unfortunately, providing excess and unused power capacity increases infrastructure and operating costs. Furthermore, if the data center can support only a limited total power, excess power means that fewer electronic components can be installed in the data center.

### BRIEF SUMMARY OF THE INVENTION

One embodiment of the present invention provides a method of controlling electrical current supplied to an electronic device. The method includes drawing up to a predetermined amount of an electrical input current from a first current source, and supplying a first portion of the drawn electrical input current to the electronic device, wherein the amount of the first portion may change over time to supply the amount of electrical current demanded by the electronic device without exceeding the predetermined amount. A second portion of the drawn electrical input current is supplied to charge an energy storage device, such as a battery, during a period that the first portion is less than the predetermined amount, wherein the second portion is no greater than the difference between the predetermined amount and the first portion. The stored energy device is discharged, as needed, to supply supplemental electrical current to the electronic device in addition to the first portion of electrical input current during a period that the amount of electrical current demanded by the electronic device is greater than the predetermined amount. Still further, the operation of the electronic device is controlled to prevent the electrical current demand from exceeding the amount of current that can be supplied from the combination of the electrical input current and the stored energy device.

Another embodiment of the invention provides a power supply. The power supply comprises an AC to DC converter providing a DC current output to supply the electrical current demand of an electronic device, a rechargeable battery in electronic communication with the DC current output, and a controller. The controller is in operative communication with the DC current output and is designed or programmed to automatically charge the rechargeable battery with a portion of the DC current output during periods that the DC current output exceeds the electrical current demand of the electronic device and automatically discharge the rechargeable battery to supply supplemental electrical current to the electronic device during periods that the electrical current demand of the electronic device exceeds the DC current output. The controller also controls the operation of the electronic device to prevent the electrical current demand from exceeding the amount of current that can be supplied from the combination of the electrical input current and the rechargeable battery. For example, the electronic device may include a processor chip, wherein the controller controls the operation of the processor by throttling.

### BRIEF DESCRIPTION OF THE SEVERAL VIEWS OF THE DRAWINGS

FIG. 1 is a block diagram of a power supply.

FIG. 2 is a schematic graph showing dynamic changes in the input current to the power supply.

### DETAILED DESCRIPTION OF THE INVENTION

One embodiment of the present invention provides a method of controlling electrical current supplied to an electronic device. The method includes drawing up to a predetermined amount of an electrical input current from a first current source, and supplying a first portion of the drawn electrical input current to the electronic device, wherein the amount of the first portion may change over time to supply the amount of electrical current demanded by the electronic device without exceeding the predetermined amount. A second portion of the drawn electrical input current is supplied to charge an energy storage device, such as a battery, during a period that the first portion is less than the predetermined amount, wherein the second portion is no greater than the difference between the predetermined amount and the first portion. The stored energy device is discharged, as needed, to supply supplemental electrical current to the electronic device in addition to the first portion of electrical input current during a period that the amount of electrical current demanded by the electronic device is greater than the predetermined amount.

In another embodiment, the method may further comprise drawing the electrical input current as alternating current (AC), converting the alternating current to direct current (DC), and supplying the first and second portions of the drawn electrical input current as direct current. The direct current being supplied to the electronic device is preferably conditioned before being provided to the electronic device. Still further, the method may provide the direct current to the battery at a first voltage, and regulate the voltage of the direct current from the first voltage down to a second voltage before supplying electrical current to the electronic device. Optionally, the method may include reducing the first voltage in response to the electrical input current reaching the predetermined amount so that the stored energy device will automatically begin to supply supplemental electrical current to the electronic device. Accordingly, a diode may be used to control the charging and discharging of the energy storage device.

In yet another embodiment, the operation of the electronic device is controlled to prevent the electrical current demand from exceeding the amount of current that can be supplied from the combination of the electrical input current and the stored energy device. For example, if the electronic device is a computer system, the operation of the computer system may be controlled by throttling the processor(s).

In still further embodiments, the stored energy device may include, without limitation, a battery, a capacitor, a fuel cell, or combinations thereof. Although a battery is the preferred energy storage device for use with most computer systems, the specific dynamics of a given system may be better served by another type of device. For example, very lengthy periods in which the current demand is less than a predetermined limit followed by very lengthy periods in which the current demand is greater than a predetermined limit might be better served by a fuel cell. For any given energy storage device, however, the amount of the second portion may be controlled to efficiently charge the energy storage device.

Another embodiment of the invention provides a power supply. The power supply comprises an AC to DC converter providing a DC current output to supply the electrical current demand of an electronic device, a rechargeable battery in electronic communication with the DC current output, and a controller. The controller is designed or programmed to automatically charge the rechargeable battery with a portion of the DC current output during periods that the DC current output exceeds the electrical current demand of the electronic device and automatically discharge the rechargeable battery to supply supplemental electrical current to the electronic device during periods that the electrical current demand of the electronic device exceeds the DC current output.

In a further embodiment, the power supply may further comprise a voltage regulator in electronic communication between the DC current output and the electronic device. The voltage regulator may improve the quality and consistency of the DC current output. Optionally, the power supply may include a diode coupled between the DC current output and the rechargeable battery to automatically control whether the battery is being charged or discharged.

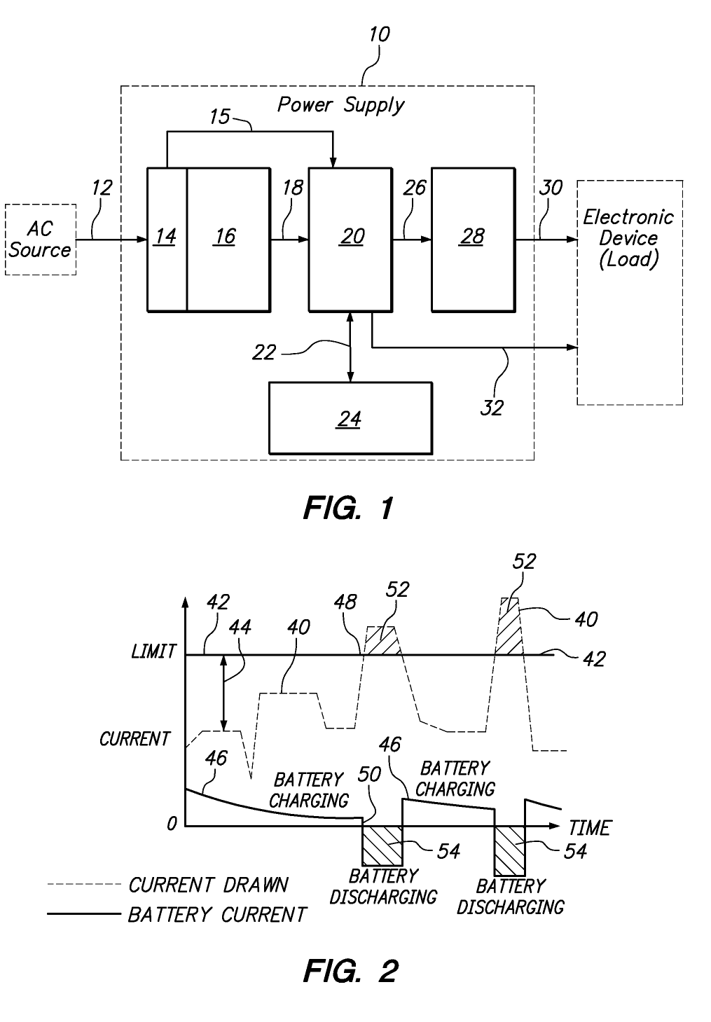

FIG. 1 is a block diagram of a power supply 10. An input 12 provides the power supply 10 with alternating current (AC). The AC current is first measured by an ammeter 14, and then conditioned, rectified, and filtered, etc. by an AC/DC converter 16. A bulk DC voltage 18 output from the converter 16 is input into a charging control circuit 20. The current measurement signal 15 from ammeter 14 is also passed to the control circuit 20.

When the control circuit 20 determines that the input current 12 is below a predetermined level, then a portion of the bulk DC output 18 is directed through a connection 22 to an energy storage device 24 (such as a battery). The output 26 from the charging control circuit 20 passes into a DC conditioning and distribution circuit 28 before providing an output 30 to an electronic device (load). The output may provide a single DC voltage or a plurality of specific regulated DC voltages.

When the control circuit 20 determines, via the measured current value 15, that the input current 12 has reached the level of the predetermined limit, then the control circuit 20 begins to draw current from the energy storage device 24, for example, through line 22. Drawing current from the energy storage device 24 allows more power to be provided by the DC output 26 of the power supply without a further increase in the AC input current 12. If the power demand of the electronic device (load) continues to increase to the point where the combined current available from the capped AC input 12 and the current from the energy storage device 24 cannot meet the demand, then the control circuit 20 can send another control signal 32 to the electronic device or load to cause the demand to be decreased. For example, where the electronic device is a computer, the control signal 32 may cause processors in the computer to throttle.

In one embodiment, the output 18 from the AC to DC converter 16 is provided at a sufficiently high voltage that the output 18 and the battery 24 may effectively be diode or'd to allow the battery to charge from a slightly higher voltage. This higher voltage is then regulated down to a usable voltage by, for example, the DC conditioning section 28. When the input circuit 12 reaches the predetermined limit, a current limiting control circuit within the charging control circuit 20 causes a reduction in the voltage in the output 18 from the AC circuit, thus allowing more current to be pulled from the battery 24. Alternately, the voltage regulator 28 can be replicated for the use with the battery 24 and the outputs of that circuit (not shown) and output 18 can be diode or'd. A current limiting arrangement similar to the one described above could be employed to force current sharing.

FIG. 2 is a schematic graph showing dynamic changes in the input current to the power supply. The graph illustrates hypothetical variations in the total amount of current drawn by an electronic device (dashed line 40). Where the total current 40 drawn by the electronic device is less than the predetermined limit (horizontal line 42), the total current drawn is satisfied entirely by the AC input current. However, the difference 44 between the current drawn by the electronic device (dashed line 40) and the predetermined limit (horizontal line 42), at any given point in time, represents current that is “available” to charge a battery. Accordingly, some of this available current capacity 44 is directed as current to the battery (solid line 46) for charging the battery.

When the current drawn by the electronic device (dashed line 40) reaches the predetermined limit (horizontal line 42) at any given point in time (for example, see point 48), the current flow to the battery reverses (see point 50, where the solid line 46 shows that the current to the battery becomes negative) and current is drawn from the battery. By drawing upon the battery, the control circuit caps the input AC current at the limit 42, but supplements the input AC current with the DC output current from the battery to satisfy the peak current requirements of the electronic device. Schematically, the demand for current (represented by the hashed areas 52) that exceeds the predetermined limit 42 is supplied by discharging the battery (represented by the hashed areas 54). So long as these peak demands do not exhaust the battery, this process may continue indefinitely so that peak current demands are met, while limiting the amount of AC current drawn. Should the battery become exhausted, or should the demand become so high that both the battery and input AC current cannot collectively meet the demand, then a control circuit must take other steps to reduce the demand. In the context of a computer system, reducing the demand may include throttling the processors.

It should be appreciated that the foregoing method and apparatus may, for example, be implemented to accommodate certain temporary operating excursions while reducing the maximum label power (nameplate rating). Accordingly, the total amount of power available to a data center can be allocated more effectively.

As will be appreciated by one skilled in the art, the present invention may be embodied as a system, method or computer program product. Accordingly, the present invention may take the form of an entirely hardware embodiment, or an embodiment combining software (including firmware, resident software, micro-code, etc.) and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of controlling electrical current supplied to an electronic device comprising:
drawing up to a predetermined amount of an electrical input current from a first current source;
supplying a first portion of the drawn electrical input current to the electronic device, wherein the amount of the first portion may change over time to supply the amount of electrical current demanded by the electronic device without exceeding the predetermined amount;
supplying a second portion of the drawn electrical input current to charge an energy storage device during a period that the first portion is less than the predetermined amount, wherein the second portion is no greater than the difference between the predetermined amount and the first portion;
discharging the stored energy device to supply supplemental electrical current to the electronic device in addition to the first portion of electrical input current during a period that the amount of electrical current demanded by the electronic device is greater than the predetermined amount; and
controlling the operation of the electronic device to prevent the electrical current demand from exceeding the amount of current that can be supplied from the combination of the electrical input current and the stored energy device.

2. The method of claim 1, further comprising:
controlling the amount of the second portion to efficiently charge the energy storage device.

3. The method of claim 1, further comprising:
drawing the electrical input current as alternating current;
converting the alternating current to direct current; and
supplying the first and second portions of the drawn electrical input current as direct current.

4. The method of claim 3, further comprising:
conditioning the direct current being supplied to the electronic device.

5. The method of claim 1, wherein the stored energy device is a battery.

6. The method of claim 1, wherein the stored energy device is a capacitor.

7. The method of claim 1, wherein the stored energy device is a fuel cell.

8. The method of claim 3, further comprising:
providing the direct current to the battery at a first voltage; and
regulating the voltage of the direct current from the first voltage down to a second voltage before supplying electrical current to the electronic device.

9. The method of claim 8, further comprising:
reducing the first voltage in response to the electrical input current reaching the predetermined amount so that the stored energy device will automatically begin to supply supplemental electrical current to the electronic device.

10. The method of claim 9, wherein the charging and discharging of the energy storage device is controlled by a diode.

11. The method of claim 1, wherein the electronic device includes a processor chip, and wherein the controller controls the operation of the processor by throttling.

12. A power supply, comprising:
an AC to DC converter providing a DC current output to supply the electrical current demand of an electronic device;
a rechargeable battery in electronic communication with the DC current output;
a controller in operative communication with the DC current output, wherein the controller automatically charges the rechargeable battery with a portion of the DC current output during periods that the DC current output exceeds the electrical current demand of the electronic device, automatically discharges the rechargeable battery to supply supplemental electrical current to the electronic device during periods that the electrical current demand of the electronic device exceeds the DC current output, and controls the operation of the electronic device to prevent the electrical current demand from exceeding the amount of current that can be supplied from the combination of the electrical input current and the rechargeable battery.

13. The power supply of claim 12, further comprising:
a voltage regulator in electronic communication between the DC current output and the electronic device.

14. The power supply of claim 13, further comprising:
a diode coupled between the DC current output and the rechargeable battery.

15. The power supply of claim 12, wherein the electronic device includes a processor chip, and wherein the controller controls the operation of the processor by throttling.
